(19) United States
(12) Patent Application Publication
(10) Pub. No.: US 2005/0197974 A1
(43) Pub. Date: Sep. 8, 2005

(54) Standardizing intelligent mail processing

(76) Inventors: Karen E. Schenck, Woodbridge, VA (US); John J. Keller, Arlington, VA (US); Bill J. Matthews, Virginia Beach, VA (US); Barbara J. McGinnis, (US)

Correspondence Address: FINNEGAN, HENDERSON, FARABOW,;GARRETT & DUNNER, L.L.P., 1300 I Street, N.W., Washington, DC, 20005, US

(21) Appl. No.: 10/950,630

(22) Filed: Sep. 28, 2004

Related U.S. Application Data
(60) Provisional application No. 60/539,118, filed on Jan. 27, 2004.
(60) Provisional application No. 60/539,962, filed on Jan. 30, 2004.

(51) Int. Cl. G06F 17/60

(52) U.S. Cl. 705/401

(57) ABSTRACT

Standardizing a mail processing system. An intelligient mail processing system provides a mail tracking code affixed to each mail piece and a mail tracking procedure using the mail tracking code. Tasks that comprise the mail processing system are identified, and the mail processing system is implemented through documentation and training. After implementation, testing insures compliance with the implemented mail processing system.

The present application claims priority to U.S. Provisional Patent Application No. 60/539,118, filed on Jan. 27, 2004, the contents of which are expressly incorporated herein by reference. The present application also claims priority to U.S. Provisional Patent Application No. 60/539,962, filed on Jan. 30, 2004, the contents of which are expressly incorporated herein by reference.

### BACKGROUND OF THE INVENTION

1. Field of the Invention

The present invention relates to methods for standardizing mail processing systems. Such methods help allow intelligent mail processing systems reach their full potential.

2. Description of the Related Art

Intelligent mail processing systems uniquely identify a mail piece using a barcode or other identifier. One such identifying barcode is the Postal Alpha-Numeric Encoding Technique (PLANET™) code developed by the U.S. Postal Service. The PLANET™ code is a standardized, data-rich, machine-readable code that makes a mail piece uniquely identifiable and trackable when processed on automation mail processing equipment.

A mail automation processing system may track a mail piece using the PLANET™ code. One such system is the CONFIRM® system developed by the USPS. In the CONFIRM® system, a unique PLANET™ code is marked on a mail piece. As the mail piece moves through the automation mail processing system, the PLANET™ code may be scanned, for example, by a wide field of view (WFOV) barcode scanner, and the scanned PLANET™ code may be matched to data about the mail piece, for example, at a central computer in the CONFIRM® system.

The PLANET™ code and the CONFIRM® system are described in published PCT Patent Application Publication No. WO 03/023677 A1, the disclosure of which is incorporated herein by reference.

Despite its many efficiencies and capabilities, the CONFIRM® system has not reached its full potential, in part because it is implemented in different ways by different parties throughout the system. To increase customer service and improve operational efficiency, it is therefore desireable to develop a process for standardizing mail processing systems such as the CONFIRM® system.

### SUMMARY OF THE INVENTION

The present invention provides methods to standardize mail processing systems. Such methods increase customer service and improve operational efficiency. Such methods further allow intelligent mail processing systems, such as the CONFIRM® system, to reach their full potential.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, the invention comprises a method for standardizing a mail processing system, the processing system providing a mail tracking code for each mail piece and a mail tracking procedure using the mail tracking code. The mail tracking procedure includes the steps of storing mail tracking data in an integrated data system and processing the mail tracking data in a processor. The method comprises the steps of identifying tasks that comprise the mail processing system; implementing the mail processing system; and testing for compliance with the implemented mail processing system.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a block diagram illustrating a customer submitting an item in a mail processing system.

FIG. 2 is a diagram illustrating a front face of an item utilizing barcode technology.

FIG. 3 is a diagram illustrating a front face of another item utilizing barcode technology.

FIG. 4 is a block diagram illustrating a customer submitting an item in a mail processing system.

FIG. 5 is a diagram illustrating a system allowing a customer to electronically access mail processing information.

FIG. 6 is a flow chart illustrating a method for standardizing a mail processing system.

FIG. 7 is a flow chart illustrating a method for standardizing a mail processing system.

FIG. 8 is a flow chart illustrating a method for standardizing a mail processing system.

FIG. 9 is a schematic diagram of a processing system adapted for use in standardizing a mail processing system.

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

Intelligent mail processing systems uniquely identify a mail piece using a barcode or other identifier. For such systems to reach their full potential, standard training, implementation, and testing methods are needed. Because of the varied stakeholders, geographic scope, varied operating procedures, and fixed resources associated with a national or international mail processing system, unique methods must be used to standardize intelligent mail processing systems.

A method for standardizing mail processing may start with identifying the tasks comprising a mail processing system. Once identified, the tasks and standard operations may be documented and training initiated. Computer aided and on-line training are preferred to maintain quality and standards while managing resources efficiently. Central digital documentation allows for consistent, uniform evolution of the mail processing standards. Once implemented, testing insures compliance with the standards.

The standardization of intelligent mail products and services may provide consistency by using best practices to outline the proper procedures related to improve mail processing techniques and delivery. For example, training in product awareness and data analysis may afford managers the necessary tools needed to make changes in the standard operating procedures needed to improve operational effectiveness.

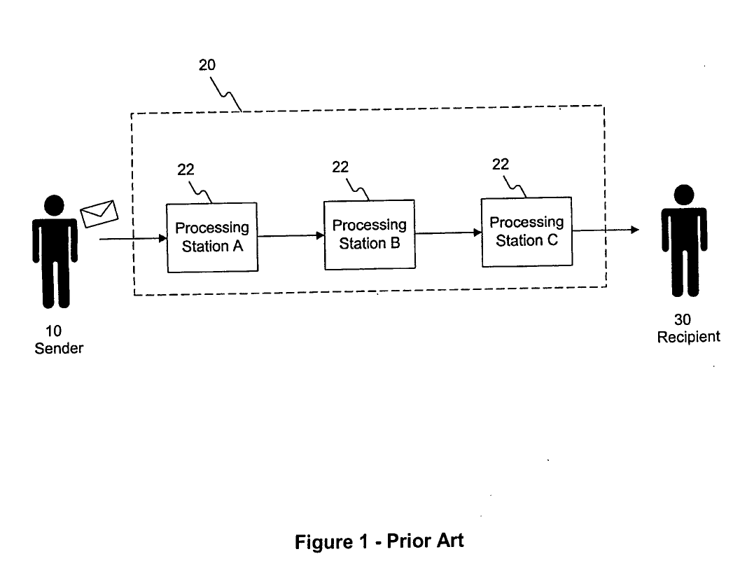

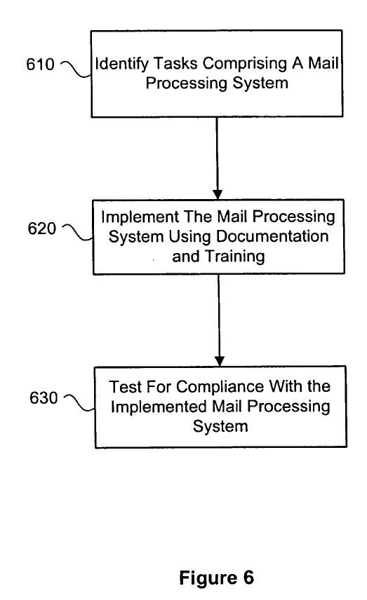

The invention will be further clarified by the following examples, which are intended to be purely exemplary of the invention. FIGS. 1-5 show example mail processing systems, while the flow charts of FIGS. 6-8 illustrate example methods for standardizing those mail processing systems.

FIG. 1 is a block diagram illustrating a customer submitting an item in a mail system. The system may include a sender 10, an item processing center 20 comprising processing stations A-C 22A, 22B, and 22C, and a recipient 30. The item may be a mail piece having any dimension, configuration, types of article, or form of container. For example, the mail piece may include a box, parcel, bundle, packet, envelope, etc. The mail piece may be a single piece from a larger mailing from sender 10. A carrier, such as a delivery truck, may transport the deposited item from sender 10 to item processing center 20.

At item processing center 20, processing stations A-C 22A, 22B, and 22C may process each item. Alternatively, items may be received from sender 10 at various presorting levels corresponding to reduced shipping rates. For example, a sender may sort the items to a fine level, e.g., by delivery carrier route, so that item processing center 20 may deliver the items immediately. A sender may perform a primary sorting of the items that require further sorting by item processing center 20. A sender 10 may perform no item sorting. Regardless of the presorting level, at each processing station 22A-C, workers for item processing center 20 may perform a number of item processing tasks, such as identifying a type of service requested for each item and determining whether a shipping fee or postage for the type of service requested is sufficient.

To aid item processing center 20 in delivering an item, a barcode identifying the delivery address of an item, such as a first barcode, may be applied to the item. Computer-controlled, high-speed machines may sort items using a barcode reader to interpret the first barcode. The barcode sorter may include an item feed, transport unit, and stackers, for example. Further, item processing center 20 may create the first barcode or a customer may create the first barcode in exchange for reduced shipping rates.

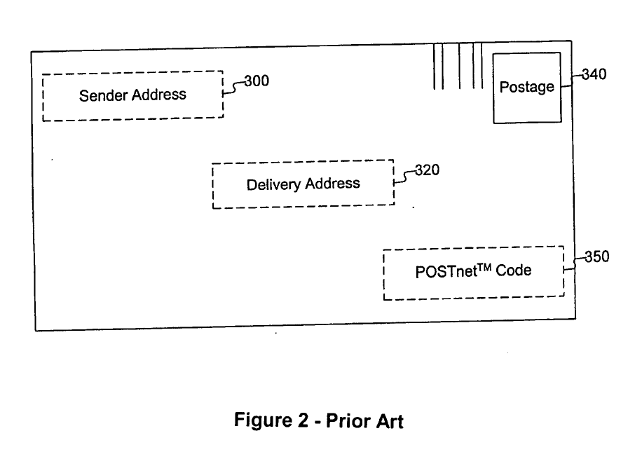

FIG. 2 is a diagram generally illustrating a front face of an item utilizing barcode technology. The front face of the item may include a sender address 300, a delivery address 320, an appropriate shipping fee or postage 340, and a first barcode 350. First barcode 350 may be used by item processing center 20 as a digital delivery address for aiding the sorting and delivery of the item from sender address 300 to delivery address 320. First barcode 350 may be printed on the front face of the item, or it may be attached thereto using a label. Typically, first barcode 350 is located at the lower right corner on the front face of the article, as shown in FIG. 2

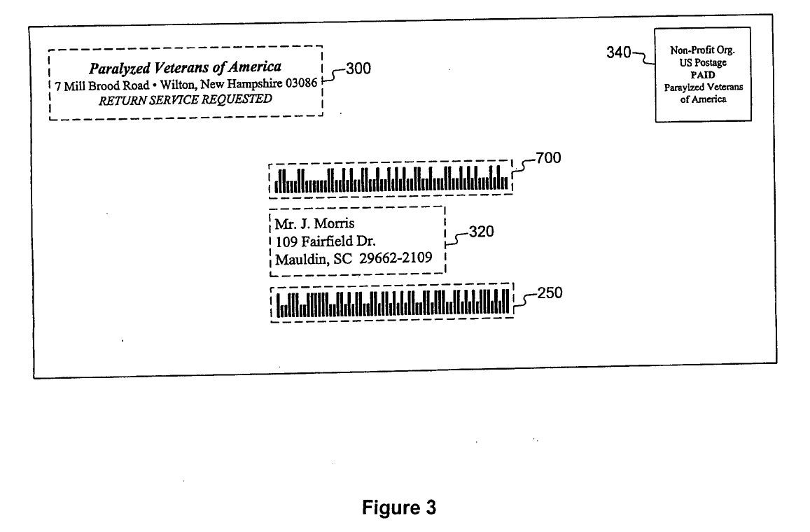

FIG. 3 is a diagram generally illustrating a front face of an item having two bar codes. A second barcode on an item may uniquely relate an item to a customer and provide tracking information regarding the item to the customer. In this manner, the customer may track incoming or outgoing items or a combination thereof. Particularly, the customer may affix or print a first barcode and a second barcode to an item. An item processing center may process the codes in combination to record information regarding the processing of an item associated with a particular customer and provide the customer with the recorded information regarding the processing of an item associated with a particular customer and provide the customer with the recorded information. Customers may access the information over a network connection to a web site or by downloading the files using file transfer protocol (FTP).

In FIG. 3, barcode 250 may represent a POSTNET code, while bar code 700 may represent a PLANET code. The PLANET code identifies the sender, and the combination of the PLANET code and the POSTNET code allows mailers to create a unique identity for their mail pieces.

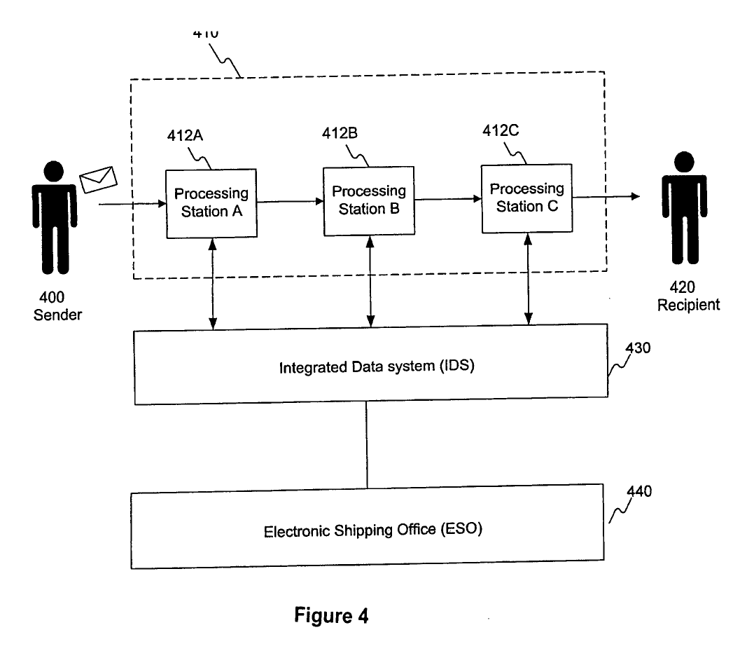

FIG. 4 is a block diagram illustrating a customer submitting an item in a shipping and tracking system. The system may include a sender 400, an item processing service 410 comprising processing stations A-C 412A, 412B, and 412C, an Integrated Data System (IDS) 430, an Electronic Post Office (EPO) 440, and a recipient 420. IDS 430 may connect processing stations A-C 412A, 412B, and 412C at a centralized location, allowing information regarding an item to be stored.

After an item is received from sender 400 at item processing service 410, processing station A 412A, for example, may scan a first barcode and a second barcode on an item to uniquely identify the item in IDS 430 and upload information into IDS 430 regarding the item. For example, processing station A may upload information regarding its location, such as its facility identification, along with a date and time for processing the item.

Similarly, processing stations B and C each may scan the first barcode and the second barcode on the item to identify the item in IDS 430 and upload updated information, regarding the location or identify of the processing station, and a date and time for processing the item. In this manner, information regarding an item, such as date, time, and location, may be processed in a processor, and the item may be tracked throughout the delivery process. IDS 430 may forward the tracking information to EPO 440, where it may be accessed by a customer associated with the item.

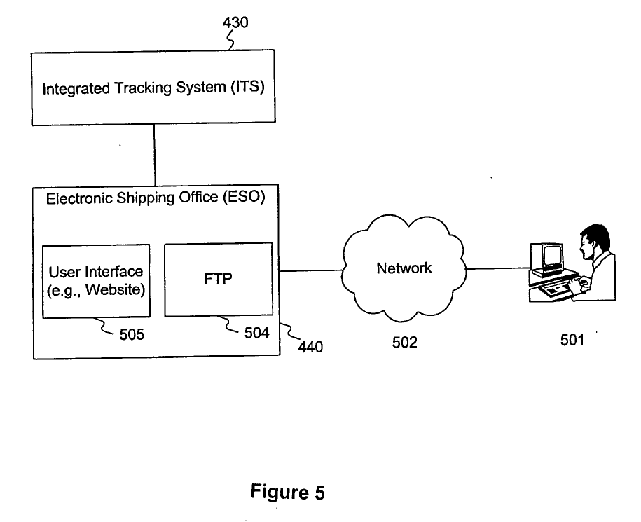

FIG. 5 is a diagram illustrating a system allowing a customer to electronically access item processing information. The system may include a subscriber 501, a network 502, an Electronic Post Office (EPO) 440 comprising a user interface or website 505 and a FTP 504, and the IDS 430. Subscriber 501 may include a customer who wishes to receive tracking information regarding outgoing items or incoming items.

The subscriber 501 may connect to EPO 440 via the network 502. EPO 440 may include data received from IDS 430. The data may be received at EPO 440 continuously or periodically throughout the day. Subscriber 501 may obtain tracking information by accessing website 505 at EPO 440 and downloading the information or, for larger files, receiving the tracking information by FTP 504. If subscriber 501 chooses to receive direct FTP access for data, the client may provide the Internet Protocol (IP) address and name of his FTP server, as well as a customer system username and password, a desired schedule for receiving the data, and a directory name for storing the data.

Mail processing systems, such as those shown in FIGS. 1-5, may be standardized according to the example methods shown in the flow charts of FIGS. 6, 7, and 8.

FIG. 6 shows steps in an example method of standardizing a mail processing system. Tasks comprising a mail processing system are identified at step 610. The mail processing system may be an intelligent mail processing system. The mail processing system is implemented using documentation and training at step 620. Digital documentation may be maintained, and on-line computer assisted training may be offered. Compliance with the implemented mail processing system is tested in step 630. Such testing may include sending test mail pieces through the mail processing system and tracking those mail pieces. The testing results might then be used to identify additional tasks or revised tasks needed to standardize the mail processing system.

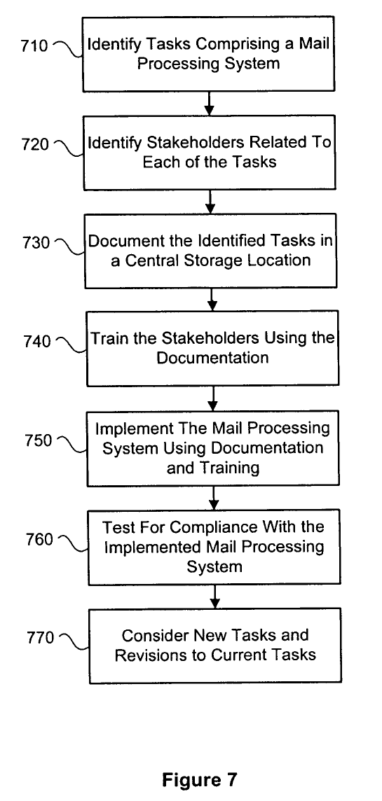

FIG. 7 shows steps in another example method of standardizing a mail processing system. Tasks comprising a mail processing system are identified in step 710. Stakeholders related to each task are identified in step 720. The stakeholders may include customers of the U.S. Postal Service. The identified tasks are documented in step 730. Digital documentation may be maintained in a central or master storage location, such as on a network server. The stakeholders are trained using the documentation in step 740. On-line computer assisted training may be offered. The mail processing system is implemented using the documentation and training in step 750. Compliance with the mail processing system is tested at step 760. Such testing may include sending test mail pieces through the mail processing system and tracking those mail pieces. New tasks and revisions to current tasks are considered at step 670. This consideration may be in response to the testing results. New tasks and revised tasks may be implemented using the same or a different method.

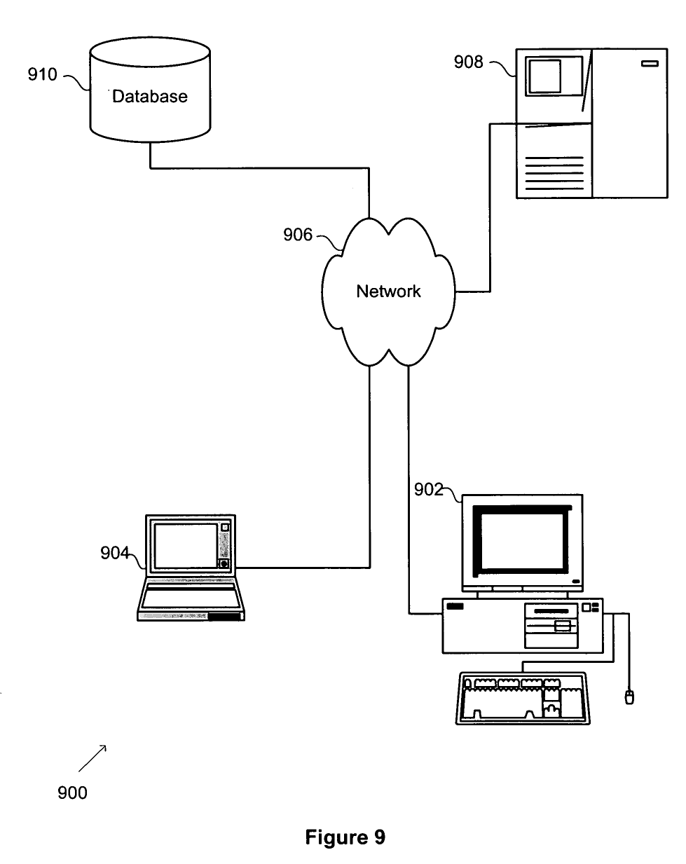

FIG. 9 shows a schematic diagram of a processing system 900 adapted for use in standardizing a mail processing system. For example, the processing system 900 can be used to store documentation and assist training. For training, including on-line training from a remote location, stake holders using a personal computer 902 or a laptop computer 904 may access training materials stored in a database 910 or a server 908 through a network 906. The database 910 may, for example, store the digital documentation.

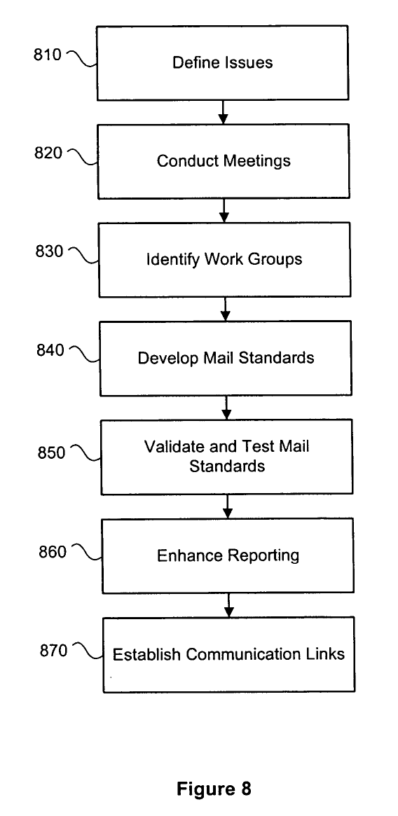

FIG. 8 shows steps in another example method of standardizing a mail processing system. Issues are defined at step 810, and meetings are conducted at step 820. Work groups are identified at step 830. Steps 810, 820, and 830 may occur in any order or at overlapping times. Mail standards are developed at step 840. The mail standards are validated and tested at step 850 and reported at step 860. Communication links are established at step 870.

As a further example, a process for standardizing the CONFIRM® mail processing system will now be described. Details of the implementation of the CONFIRM® mail processing system are shown in the document entitled “Welcome to CONFIRM® Service Standardization Training” and the document entitled “Welcome to CONFIRM® Service Standardization Training.” These two documents are included in U.S. Provisional Patent Application No. 60/539,962, filed on Jan. 30, 2004, the contents of which are expressly incorporated herein by reference.

A process for standardizing the CONFIRM® mail processing system may include several steps such as increasing awareness of the CONFIRM® system, developing end-to-end work instructions for those individuals responsible for implementing the CONFIRM® system, and educating those involved.

Work instructions were developed by identifying each step in the CONFIRM® system and the tasks needed to complete each step for maximum operational efficiency and success. For example, customers, marketing people, sales people, and operations people may all play a role in the CONFIRM® process and may therefore be assigned tasks. Within each group of individuals, managers may be given tools for ensuring that their employees are made fully aware of their roles and responsibilities related to this product.

To develop a standardized mail processing system, a service improvement plan may be created to identify the individuals involved and to design a training and implementation schedule for the standardization program. A sample service improvement plan is described in the document entitled “CONFIRM® Service Improvement Plan.”

To standardize service in the CONFIRM® system, training programs may be developed to train external customers and internal stakeholders such as Marketing, Operations, and Sales. One example of standardized web training that may be offered is described on pages 188-199 of the document entitled “Welcome to CONFIRM® Service Standardization Training.”

To enhance the implementation of the CONFIRM® program, standard customer features, standard administrative features, and standard operational features are identified and implemented. Customer features include customer registration, barcode creation and application, pre-shipment notification, customer data access, and smart seed tracking. Administrative features include origin office acceptance procedure, mail piece quality assurance, security of report access for internal user, report access for marketing and sales users, and business service network support. Operational features include securing access to reports for internal users, subscriber identifiers for internal users, receipt of mailings, network communications, internal seeding, and report access for operations personnel.

Standardizing customer features will now be described.

To take advantage of the CONFIRM® system, a customer, such as a mailer, must register, and customer registration is a customer feature. The customer completes an application to obtain a customer ID, a password, and authorization to print and track PLANET™ codes. The customer may submit payment for the right to use the CONFIRM® system. After a customer is initially authorized, the customer may modify, renew, or cancel their registration with the CONFIRM® system. One example of a standardized customer registration process is described on pages 27-34 of the document entitled “Welcome to CONFIRM® Service Standardization Training.”

The customer may create barcodes and apply the barcodes to a mail piece. Once a customer is registered to participate in the CONFIRM® system, instructions may be provided for creating and applying barcodes such as PLANET™ codes. One example of a standardized implementation of the barcode creation and application process is described on pages 36-49 of the document entitled “Welcome to CONFIRM® Service Standardization Training.”

Customers in the CONFIRM® system may take advantage of several services before mail pieces are even shipped. Pre-shipment notification is a customer feature. Customers may provide mail piece details to a central processor to obtain additional data about a shipment including the mail piece, such as postage costs and expected delivery time. Examples of standardized pre-shipment notification services are described on pages 50-57 of the document entitled “Welcome to CONFIRM® Service Standardization Training.”

Once a mail piece is shipped using the CONFIRM® system, customers may access data about the mail piece using the PLANET™ code. For example, customers may obtain data regarding when and where the mail piece's PLANET™ code is scanned, a projected time of delivery, etc. Examples of standardized customer data access are described on pages 59-66 of the document entitled “Welcome to CONFIRM® Service Standardization Training.”

Testing mail processing systems is a customer feature. A “smart seed” feature of the CONFIRM® system enables customers to use generic mail pieces to track PLANET™ code data without being delivered to an end recipient. For example, smart seed mail pieces may be similar in look and configuration to those being sent to actual customers, but the smart seed pieces are addressed to a Postmaster or Station Manager and coded with PLANET™ barcode. Once a smart seed mail piece reaches the Postmaster or Station Manager, it may be discarded. Alternatively, real, or “live” mail pieces may be treated as smart seed mail pieces and tracked as such. Customers may use smart seed mail pieces, for example, to test performance of a component of the CONFIRM® system. Examples of a standardized smart seed feature are described on pages 67-71 of the document entitled “Welcome to CONFIRM® Service Standardization Training.”

Standardizing administrative features will now be described.

Origin office acceptance is an administrative feature. When a mailing is submitted by a customer, the CONFIRM® system verifies and accepts the mailing. For example, the mailing may be compared to criteria, such as a mail piece count or postage calculations, in order to be verified. Examples of a standardized origin office acceptance procedure are described on pages 75-80 of the document entitled “Welcome to CONFIRM® Service Standardization Training.”

Mail piece quality assurance is another administrative feature. When a customer presents mail pieces to the CONFIRM® system, the quality of the mail pieces may be measured. For example, the PLANET™ codes printed on the mail pieces may be examined to ensure machine-readability. Examples of standardized mail piece quality assurance are described on pages 85-90 of the document entitled “Welcome to CONFIRM® Service Standardization Training.”

The CONFIRM® system provides secure access for internal users to view reports containing CONFIRM® data. The security may be provided, for example, by requiring user identification codes and/or manager approval. An example of standardized secure access to reports is described on pages 91-101 of the document entitled “Welcome to CONFIRM® Service Standardization Training.”

Marketing and Sales users may obtain report access. Report access is an administrative feature. Data collected and analyzed by the CONFIRM® system may be made available through both internal reports and through reports shared with customers. Examples of internal reports include: Origin to Destination Summary Report, Entry Scan Summary Report, Mail Piece Summary Report-USPS, Late Mail from Originating Facility Report, and Performance by Location Report. Examples of shared reports include: Delivery vs. Service Goal Report, In Home Window Delivery Report, Mailer Quality Report, Confirm Problems Report, and Mail Piece Summary Report. Descriptions of the above reports are available on pages 105 and 107 of the document entitled “Welcome to CONFIRM® Service Standardization Training.”

Business Service Network support is an administrative feature of the CONFIRM® system. When problems arise, they may be acknowledged and managed quickly. Service goals and procedures may be implemented to meet customer support needs. Examples of standardized customer support goals and procedures are having a local customer service representative notify a customer of status within 24 hours of a service issue request and resolving customer issues within 48 hours of request receipt. Other standardized customer support goals and procedures are described on pages 111-120 of the document entitled “Welcome to CONFIRM® Service Standardization Training.”

Standardizing Operational Features will now be described.

A mail processing system consistent with an embodiment of the present invention may be administered by a number of internal users, such as employers and/or contractors of the mail processing system provider. These internal users may prepare and access reports based on data such as CONFIRM® data. Securing access to reports for internal users is an operational feature, and securing login access to service reports on http://edw.usps.gov is an operational feature of the CONFIRM® mail processing system. Access to the reports allows users to review and analyze performance related to CONFIRM® system mailings, identify the root causes of situations, take pro-active corrective action, and identify opportunities for operational improvement. Examples of standardized procedures for securing internal users access to reports are described on pages 124-134 of the document entitled “Welcome to CONFIRM® Service Standardization Training.”

Internal users may use identifiers, such as subscriber IDs, to obtain access to CONFIRM® data, reports, etc. In this way, internal users may track mail pieces, provide customer service, etc. Examples of standardized procedures for providing subscriber IDs for internal users are described on pages 136-139 of the document entitled “Welcome to CONFIRM® Service Standardization Training.”

Receipt of mailing is an operational feature. When a mailing is delivered to a mail processing facility, e.g., a destination entry post office, internal users may receive, verify, and process the mailing. For example, the receiving person may scan a barcode from the mailing, complete forms related to the mailing, inspect the mailing, etc. Example of standardized procedures for receiving a mailing are described on pages 141-149 of the document entitled “Welcome to CONFIRM® Service Standardization Training.”

Network communication is an operational feature. To provide a mail processing system such as CONFIRM® to an existing system, modifications to existing devices such as bar code scanners and networks, may be necessary or desirable. For example, a bar scan and code porter may be modified to enable it to transmit PLANET codes as it processes mail pieces. Examples of standardized network communication modifications are described on pages 151-157 of the document entitled “Welcome to CONFIRM® Service Standardization Training.”

Internal testing is an operational feature. Internal users of a mail processing system such as CONFIRM® may wish to collect and analyze CONFIRM® data using a “seed” mail piece. A seed mail piece may be created and sent by an internal user for example, to measure performance of the system. The seed mail piece may be, for example, any mail type including letters, flats and in the future, parcels marked with the address of a processing facility and a PLANET™ code. Alternatively, “live” mail pieces of any mail type including letters, flats and in the future, parcels may be identified and treated as seed pieces. Examples of standardized internal seeding are described on pages 159-178 of the document entitled “Welcome to CONFIRM® Service Standardization Training.”

Operations personnel, such as In-Plant Support, Quality, Maintenance, and Distribution Operations may access CONFIRM® data and/or reports, for example, to identify or correct problems. Example reports, available to internal users, are: Point-to-Point Report, Origin to Destination Summary, Entry Scan Summary, Mail Piece Summary-USPS, Late Mail from Originating Facility, and Performance by Location. Page 184 of the document entitled “Welcome to CONFIRM® Service Standardization Training” contains descriptions of these six reports. Examples of standardized procedures to provide operations personnel with report access are described on pages 180-186 of the document entitled “Welcome to CONFIRM® Service Standardization Training.” In addition, many operations personnel opt to secure internal testing results through http://imaq.usps.gov. Users can secure summary and performance reports as well as individual scan data of individual mail pieces.

Embodiments of the present invention have been directed to processors and to computer readable media that perform steps in a method for standardizing intelligent mail processing. Examples of computer readable media, consistent with embodiments of the invention include hard drives, magnetic disks, optical disks, solid state memory, and web pages, and the programs contained therein. The systems and methods disclosed herein are not related to any particular computer or other apparatus, and may be implemented by any suitable combination of hardware, software, and/or firmware. For example, various general purpose machines may be used with programs written in accordance with teachings of the embodiments of the invention, or it may be more convenient to construct a specialized apparatus or system to perform the required methods and techniques

Embodiments of the invention have been related to program instructions or code for performing various computer-implemented operations based on the methods and processes of the invention. The media and program instructions may be those specifically designed and constructed for the embodiments of the invention, or they may be of the kind well-known and available to those having ordinary skill in the computer software arts. Examples of program instructions include both machine code, such as produced by a computer, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for standardizing a mail processing system, the mail processing system providing a mail tracking code for each mail piece and a mail tracking procedure using the mail tracking code, the mail tracking procedure including the steps of storing mail tracking data in an integrated data system and processing the mail tracking data in a processor, the method comprising the steps of:
identifying tasks that comprise the mail processing system;
implementing the mail processing system; and
testing for compliance with the implemented mail processing system.

2. The method of claim 1, wherein the mail processing system is the CONFIRM® system.

3. The method of claim 2, wherein the identified tasks include standard customer features, standard administrative features, and standard operational features.

4. The method of claim 3, wherein the standard customer features include barcode creation and application, pre-shipment notification, and customer data access.

5. The method of claim 2, wherein the step of testing for compliance includes the step of smart seed tracking.

6. The method of claim 2, wherein said implementation step includes the step of documenting the identified tasks in a central storage location.

7. The method of claim 6, wherein the documentation includes a training manual.

8. A method for standardizing a mail processing system, the mail processing system providing a mail tracking code for each mail piece and a mail tracking procedure using the mail tracking code, the mail tracking procedure including the steps of storing mail tracking data in an integrated data system and processing the mail tracking data in a processor, the method comprising the steps of:
identifying tasks that comprise the mail processing system;
identifying stakeholders related to each of the tasks;
documenting the identified tasks; and
training the stakeholders using the documentation.

9. The method of claim 8, wherein the mail processing system is the CONFIRM® system.

10. The method of claim 9, wherein the stakeholders include customers.

11. The method of claim 9, wherein the identified tasks include standard customer features, standard administrative features, and standard operational features.

12. The method of claim 11, wherein the standard customer features include barcode creation and application, pre-shipment notification, and customer data access.

13. The method of claim 9, wherein the documentation includes a training manual.

14. A method for standardizing a mail processing system, the mail processing system providing a mail tracking code for each mail piece and a mail tracking procedure using the mail tracking code, the mail tracking procedure including the steps of storing mail tracking data in an integrated data system and processing the mail tracking data in a processor, the method comprising the steps of:
identifying tasks that comprise the mail processing system;
documenting the identified tasks in a central storage location; and
creating computer aided training materials using the documentation, the training materials being accessible from a location remote from the central storage location.

15. The method of claim 14, wherein the mail processing system is the CONFIRM® system.

16. The method of claim 15, wherein the identified tasks include standard customer features, standard administrative features, and standard operational features.

17. The method of claim 16, wherein the standard customer features include barcode creation and application, pre-shipment notification, and customer data access.

18. The method of claim 15, wherein the documentation includes a training manual.

19. The method of claim 14, further comprising the steps of identifying stakeholders related to each of the tasks and training the stakeholders using the documentation.

20. The method of claim 19, wherein the mail processing system is the CONFIRM® system.

21. The method of claim 20, wherein the identified tasks include standard customer features, standard administrative features, and standard operational features.

22. An apparatus for standardizing a mail processing system, the mail processing system providing a mail tracking code for each mail piece and a mail tracking procedure using the mail tracking code, the mail tracking procedure including the steps of storing mail tracking data in an integrated data system and processing the mail tracking data in a processor, the apparatus comprising:
means for documenting tasks in a central storage location, the documented tasks comprising the mail processing system;
means for creating computer aided training materials using the documentation, the training materials being accessible from a location remote from the central storage location; and
means for training stakeholders related to each of the tasks using the documentation.

23. The apparatus of claim 22, wherein the mail processing system is the CONFIRM® system.

24. The apparatus of claim 23, wherein the identified tasks include standard customer features, standard administrative features, and standard operational features.

25. A computer readable medium having contents for causing a computer-based information handling system to perform steps for standardizing a mail processing system, the mail processing system providing a mail tracking code for each mail piece and a mail tracking procedure using the mail tracking code, the mail tracking procedure including the steps of storing mail tracking data in an integrated data system and processing the mail tracking data in a processor, the steps comprising:
documenting tasks in a central storage location, the documented tasks comprising the mail processing system;
creating computer aided training materials using the documentation, the training materials being accessible from a location remote from the central storage location; and
training stakeholders related to each of the tasks using the documentation.

26. The medium of claim 25, wherein the mail processing system is the CONFIRM® system.

27. The medium of claim 26, wherein the identified tasks include standard customer features, standard administrative features, and standard operational features.
